(19) United States
(12) Patent Application Publication
(10) Pub. No.: US 2026/0057166 A1
(43) Pub. Date: Feb. 26, 2026

(54) PRESENTATION FORMATS FOR RENDERING CONTENT ASSOCIATED WITH INTERACTABLE COMPONENTS

(71) Applicant: Honeywell International Inc., Charlotte, NC (US)

(72) Inventors: Timothy Sneed, Beachwood, NJ (US); Ankit Singh, Apex, NC (US); Abhishek Hiremath, Scarborough (CA); Arun Ramasubrahmanyan, Burlington, NJ (US)

(21) Appl. No.: 18/811,766

(22) Filed: Aug. 22, 2024

(51) Int. Cl. G06F 40/103; G06F 3/0481; G06F 3/04842; G06F 3/04845

(52) U.S. Cl. CPC G06F 40/103; G06F 3/0481; G06F 3/04842; G06F 3/04845

(57) ABSTRACT

Approaches for generating presentation formats for rendering content associated with interactable components are described. According to one example, an interactable component may be selected and positioned within a portion of a user interface. The interactable component may be configured, based on configuration settings, to establish communication with a data source and to render data retrieved from the data source as visual information. With the interactable component configured, a presentation format may be generated.

### BACKGROUND

Quality management or such other software platforms may be used for digital quality management, and to automate and standardize quality procedures for industrial processes to achieve a process objective or an end result. Examples of the process objective may include, but is not limited to, a product which is manufactured, services rendered, information processed, or any other activity that may be performed for accomplishing predefined functional or operational tasks within an organization. The various processes may be tracked through various dashboards implemented by said software platforms. The dashboards may provide information and insights pertaining to different metrics pertaining to the industrial process being managed or monitored.

### SUMMARY OF INVENTION

This summary is provided to introduce concepts related to implementing programmable interactable component in different presentation formats. This summary is not intended to identify essential features of the claimed subject matter nor is it intended for use in determining or limiting the scope of the claimed subject matter.

In an aspect of the present subject matter, a system for implementing programmable interactable component in different presentation formats is disclosed. The system includes a processor and a machine-readable storage medium comprising instructions executable by the processor. The instructions when executed cause the processor to enable selection, through user input, of an interactable component. The interactable component is programmable and is to provide visual information on a user interface. Further, the instructions when executed cause the processor to position the selected interactable component within a portion of the user interface. In an example, one of a shape and relative position of the interactable component is changeable with respect to position of a plurality of other elements in the user interface. The instructions when executed also cause the processor to configure, based on configuration settings received through another user input, the interactable component. The interactable component when configured is to establish a communication channel with a data source to retrieve data and render the data, as per the configuration settings, as the visual information. In addition, the instructions cause the processor to generate a presentation format comprising content. The content is to further comprise the visual information provided by the interactable component based on the configuration settings and the plurality of other elements.

In an aspect of the present subject matter, a method for implementing programmable interactable component in different presentation formats is disclosed. The method includes receiving a request for rendering content of a presentation format. The content comprises visual information to be provided by a programmable interactable component implemented within the presentation format. The method further includes parsing the presentation format to detect relative position of the interactable component and other plurality of components in the presentation format. In addition, the method includes retrieving data corresponding to the interactable component. Based on the retrieved data, a segmented rendering of the visual information is derived. Thereafter, the method includes generating a descriptive code defining a printable format corresponding to the presentation format comprising the segmented rendering of the visual information.

In yet another aspect of the present subject matter, a non-transitory computer readable medium for implementing programmable interactable component in different presentation formats is disclosed. The non-transitory computer readable medium has instructions stored thereon. The instructions, when executed by a processor, cause the processor to perform operations. In the operations, in response to user input, selection of an interactable component is caused. The interactable component is programmable and is to provide visual information. The selected interactable component is positioned within a portion of a user interface. One of a shape and relative position of the interactable component is changeable with respect to position of an adjacent element. Further, based on configuration settings received through another user input, the interactable component is configured. The interactable component when configured is to establish a communication channel with a data source to retrieve data and render the data, as per the configuration settings. The data is rendered as the visual information. In addition, a presentation format is generated comprising content. The content comprises the visual information provided by the interactable component and other plurality of elements, based on the configuration settings.

### BRIEF DESCRIPTION OF FIGURES

Systems and/or methods are now described, in accordance with examples of the present subject matter and with reference to the accompanying figures, in which:

FIG. 1 illustrates a system for generating a presentation format for rendering content, according to an example;

FIG. 2 illustrates a communication environment comprising a system for generating a presentation format for rendering content, according to an example;

FIG. 3 illustrates a schematic block diagram of a dashboard for generating a presentation format for a report, according to an example;

FIG. 4 illustrates a schematic block diagram of a dashboard for generating a presentation format for a chapter of a report, according to another example;

FIGS. 5A-5C illustrate different stages involved in defining and generating a printable format corresponding to a presentation format, according to an example;

FIG. 6 illustrates a call flow diagram for generating a presentation format for rendering content, according to an example;

FIG. 7 illustrates a call flow diagram for generating a printable format corresponding to a presentation format for rendering content, according to another example;

FIG. 8 illustrates a method for generating a printable format corresponding to a presentation format for rendering content, according to an example;

FIG. 9 illustrates a method for generating a printable format corresponding to a presentation format for rendering content, according to another example; and

FIG. 10 illustrates a computing environment implementing a non-transitory computer-readable medium for generating a presentation format for rendering content, according to an example.

### DETAILED DESCRIPTION

As discussed above, software platforms may be used for digital quality management, enabling automation and standardization of quality procedures, or for monitoring different stages implemented within industrial processes. The various processes may be tracked through various dashboard which provide information or insights depicted through a variety of presentation formats. Although many such reporting functions (by way of presentation formats) may be available, the same may lack consistency in the rendering of the information and/or metrics across multiple presentation formats. These issues may pose additional challenges where such presentation formats may be required across multiple quality procedures which may target different aspects of an otherwise common industrial process with each procedure or process adopting different presentation formats. As a result, in many instances the same information may end up getting represented in different formats or representations. Such disparate presentation formats may impact the relevance of the information being provided. This in turn may impact any decisional measures that may have to be adopted to address any technical issues within the industrial process.

Approaches for generating a presentation format or a printable format for rendering content are described. The described approaches enable consistent configuration of user interfaces of dashboards across different quality and/or management processes being implemented by management software platforms. In an example, the present approaches may be utilized for dynamic content rendering using one or more interactable components that may be implemented within the software platforms. In addition, the present approaches may be utilized for generating exportable presentation formats, such as reports or other documentation in different printable formats (such as PDF).

To this end, implementing programmable interactable component in different presentation formats are described. The interactable component may be associated with integrated executable code which when executed enables retrieval of data from a data source. The retrieved data, once fetched, may be rendered by the interactable component implemented within the presentation formats as visual information. The interactable component to be implemented may be initially selected by way of user input. Upon selection, the interactable component may be positioned within a portion of the user interface. In an example, the interactable component is such that its shape and/or relative position of the interactable component is changeable when placed along with or adjacent to a plurality of other elements present in the user interface. The other elements may include static elements, i.e., elements which do not change or do not render visual information pertaining to data retrieved from data sources.

Once the interactable component is positioned, the same may be configured based on one or more configuration settings. The configuration settings may enable the interactable component to perform one or more functions. In an example, once configured, the interactable component may be capable of establishing a connection with one or more data sources to retrieve data, and thereafter render the data as visual information within the user interface. The data may be retrieved for specific instant or may be retrieved intermittently or periodically. In case of the latter, the visual information may also vary (i.e., is dynamic).

The visual information is provided in the portion of the user interface where the interactable component is positioned. In an example, the manner of representation of the visual information may depend on the configuration settings. For example, the configuration settings may specify that the data retrieved is to be depicted as graph or in a specific chart. In a similar manner, the configuration settings may be utilized for specifying the manner in which the visual information is presented by the interactable component.

With the interactable component configured, a presentation format for presenting content may be generated. The content to be rendered within the presentation format comprises the visual information provided by the interactable component and one or more elements which may have been positioned onto the user interface. Upon deployment, the integrated executable code associated with the interactable component may be executed to retrieve data from the configured data source and in conformance with the configuration settings.

As discussed previously, the present approaches may be utilized for generating exportable presentation formats, such as reports or other documentation in different printable formats (such as PDF). In an example, a request for rendering content of a presentation format may be initially received. The content comprises visual information to be provided by a programmable interactable component (upon deployment), with the interactable component being implemented within the presentation format. The presentation format may thereafter be parsed to detect relative position of the interactable component and other plurality of components that may be implemented in the presentation format. In an example, once the interactable component is detected, the data corresponding to the interactable component may be retrieved based on the configuration setting. Once the data is received, a segmented rendering of the visual information may be derived. As may be noted, the visual information may change depending on the data sources and the data being retrieved. A segmented rendering may include, but may not be limited to, a point-in-time snapshot of the visual information rendered at the instant the presentation format is parsed.

Once the segmented rendering is derived, a descriptive code defining a printable format may be generated retaining the positioning of the interactable component (and the generated visual information) along with the other elements that may have been provided in the user interface. In an example, the descriptive code defining a printable format may refer to page description language defining appearance attributes corresponding to a printable file format. The described approaches thus enable consistent configuration of user interfaces of dashboards across different quality and/or management processes for dynamic content rendering, while also enabling seamless viewing. In addition, the described approaches provide flexible layouts of the presentation formats to enable multi-platform support while rendering the content.

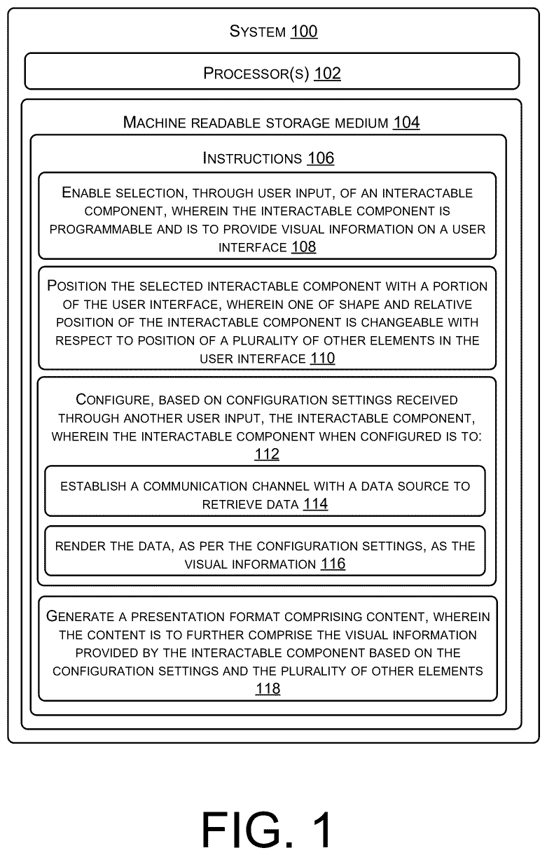

The present subject matter is further described with reference to FIG. 1 to FIG. 10. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates a system 100 for implementing an interactable component in different presentation formats, according to an example. The interactable component may be programmable or may be associated with integrated executable code, which when executed enables retrieval of data from a data source. The interactable component may be implemented within a user interface and is to retrieve, process, and visually present data. Examples of interactable components may include, but are not limited to, a widget, a digital component, a graphical user interface (GUI) element, and an interactive dashboard element. The interactable component may render retrieved data in various visual formats, such as charts, graphs, tables, or other graphical representations, and may update the visual information dynamically based on changes in the underlying data or user interactions.

The interactable component may be used to customize a presentation format. The presentation format may refer to an arrangement, style, or overall appearance-based layout for content that is displayed to a user. The presentation format may include, but is not limited to, a layout of portions corresponding to text and images on a screen, a color scheme and font choices, organization of data within charts or tables, and transitions or animations between different pieces of content. The interactable component may allow users to alter these aspects of the presentation format based on preferences.

The system 100 may be a device, such as an electronic device, that may be operated by a user for implementing the interactable component. Examples of the electronic device may include, but are not limited to, a laptop, a desktop, a tablet computer, and a smartphone. The system 100 may be implemented in any computing system, such as a storage array, server, desktop or a laptop computing device, a distributed computing system, or the like. Although not depicted, the system 100 may include other components, such as interfaces to communicate over the network or with external storage or computing devices, display, input/output interfaces, operating systems, applications, data, and other software or hardware components (all of which have not been depicted).

In one example, the system 100 may be a standalone server or may be a remote server on a cloud computing platform. In a preferred example, the system 100 may be a cloud-based system. The system 100 is capable of delivering applications (such as cloud applications) for creating and executing queries on the data content.

The system 100 may include a processor 102 and a machine-readable storage medium 104 which is coupled to, and accessible by, the processor 102. The processor 102 may be implemented as a dedicated processor, a shared processor, or a plurality of individual processors, some of which may be shared. The processor(s) 102 may include microprocessors, microcomputers, microcontrollers, digital signal processors, central processing units, state machines, logic circuitries, and/or any other devices that manipulate signals and data based on computer-readable instructions. Further, functions of the various elements shown in the figures, including any functional blocks labelled as “processor(s)”, may be provided through the use of dedicated hardware as well as hardware capable of executing computer-readable instructions.

The machine-readable storage medium 104 may be communicatively connected to the processor 102. Among other capabilities, the processor 102 may fetch and execute computer-readable instructions, including instructions 106, stored in the machine-readable storage medium 104. The machine-readable storage medium 104 may include non-transitory computer-readable medium including, for example, volatile memory such as RAM (Random Access Memory), or non-volatile memory such as EPROM (Erasable Programmable Read Only Memory), flash memory, and the like. The instructions 106 may be executed to classify the hardware components of the computing device.

In an example, the processor 102 may fetch and execute instructions 106. In one example, as a result of the execution of the instructions 108, the system 100 may enable selection of the interactable component through user input. The interactable component may be programmable and may provide visual information on a user interface. The user input for selecting the interactable component may be received through various input methods, such as touch input on a touchscreen, mouse clicks, keyboard shortcuts, voice commands, or gesture recognition. In an example, the system 100 may provide visual or haptic feedback to confirm the selection of the interactable component.

Upon selection of the interactable component, the instructions 110 may be executed to allow to position the selected interactable component within a portion of the user interface. In an example, one of a shape and relative position of the interactable component is adaptive with respect to the position of a plurality of other elements in the user interface. This enables the adjustment of the size of the interactable component, as it is adaptively positioned amongst the other components that may have been previously provided on the user interface. In addition to the interactable components, the user interface may further include one or more static elements, i.e., elements which do not change or do not render data retrieved from data sources. In an example, the interactable component may be customizable, allowing users to modify the appearance, behavior, or functionality of the interactable component. The customization options may include resizing the interactable component, reshaping the interactable component, changing colors or fonts of the interactable component, adding or removing features of the interactable component, or adjusting the interactable component's responsiveness to user interactions.

Upon positioning the interactable component, the instructions 112 may be executed to configure the interactable component based on configuration settings received through another user input. The configuration settings may enable the interactable component to perform one or more functions. The configuration settings may include parameters, such as data source selection, update frequency, display format, and other such parameters that may define the content and the manner in which the data thus retrieved, may be rendered. To this end, the instructions 114 may be executed such that the interactable component is to establish a communication channel with a data source for retrieving data. In an example, the communication channel may be established using various protocols, such as HTTP, HTTPS, or proprietary APIs, depending on the nature of the data source and the requirements of the system 100. Once configured to establish the communication channel, the instructions 116 may further configure the interactable components to render the data as the visual information in the interactable components, based on the configuration settings.

Further, upon configuring the interactable component, the instructions 118 may cause the processor 102 to generate a presentation format comprising the one or more interactable components. The presentation format may indicate a structured arrangement for displaying and organizing content, retrieved by the interactable components, which may be rendered across various mediums and devices. In some aspects, the presentation format may also refer to exportable formats, such as reports or other documentation in different printable formats, including but not limited to, Portable Document Format (PDF) and Extensible Markup Language (XML) Paper Specification (XPS). The presentation format may be optimized for different display sizes and orientations, ensuring a responsive design that adapts to various devices such as desktop computers, tablets, and smartphones.

The above functionalities performed as a result of the execution of the instructions 108, may be performed by different programmable entities. Such programmable entities may be implemented through any computing systems, which may be implemented either on a single computing device, or multiple computing devices. As will be explained, various examples of the present subject matter are described in the context of a computing system which obtains interactable components as a result of user selection and generate presentation formats. These and other examples are further described with respect to the remaining figures.

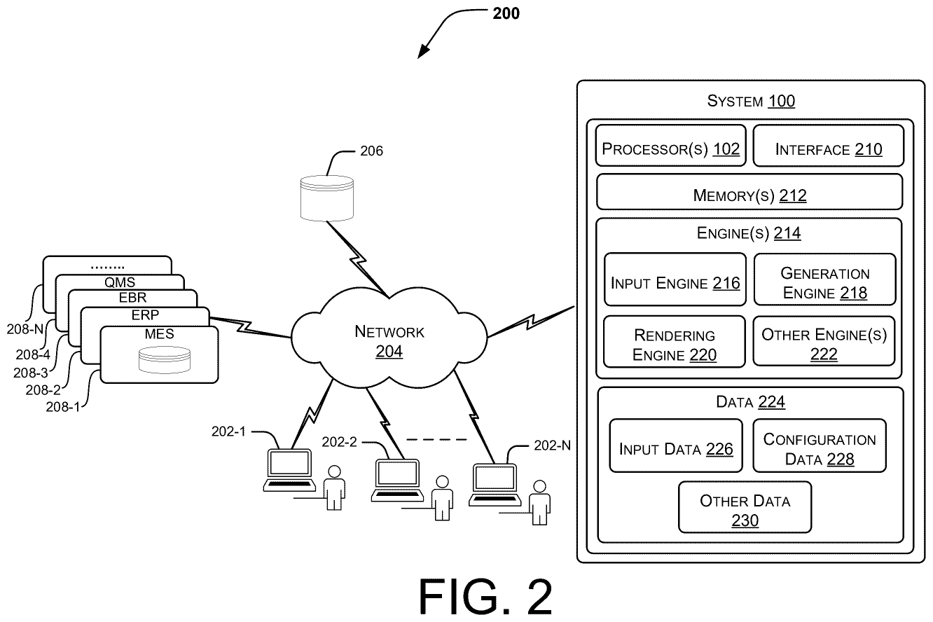

FIG. 2 illustrates a communication environment for generating a presentation format for rendering content, according to an example. The communication environment 200 includes the system 100 for generating a presentation format for rendering content. The system 100 is described in FIG. 1 and may include, but is not limited to, a laptop, a notebook computer, a server computer, and a tablet computer. The system 100 may connect with a plurality of user devices 202-1, 202-2, . . . , 202-N, collectively referred to as user devices 202 and individually referred to as a user device 202, through a network 204. The user devices 202 may include, but are not limited to, a laptop, a notebook computer, a tablet computer, and a desktop. In an example, users such as administrators of various departments of an organization may access the system 100 through the user devices 202 to generate various templates based on their requirements.

The network 204 may be a wireless network, a wired network, or a combination thereof. The network 204 can also be an individual network or a collection of many such individual networks, interconnected with each other and functioning as a single large network, e.g., the Internet or an intranet. The network 204 can be implemented as one of the different types of networks, such as intranet, local area network (LAN), wide area network (WAN), the internet, and such. The network 204 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other.

The system 100 may include the processor(s) 102 as depicted in FIG. 1. Further, in an example, the system 100 may be connected to a repository 206 through the network 204. The repository 206 may store data in either a structured or an unstructured format. In another example, the repository 206 may be configured as cloud-based repository implemented in organization environments. In another example, the repository 206 may be a location on a file system directly accessible by the engines. The repository 206 may be configured to store data pertaining to various templates defined by the users. The data stored in the repository 206 may include, but is not limited to, presentation formats pertaining to various departments or sections of an organization, preferences of different users with respect to dashboard layout, list of interactable components included in the templates, version history pertaining to different presentation formats, predefined configuration settings, and so on. A presentation format may be referred to a structured layout for organizing and displaying content which may be designed to facilitate the creation, viewing, and output of information across multiple platforms and devices.

In one example, the system 100 may be connected to one or more systems of record (SOR) 208 through the network 204. The SOR 208 may represent available data sources that include relational data repositories and operational data stores including structured and unstructured data (e.g., collections of files, documents, sheets, etc.). The data in the SOR 208 corresponds to operations, processes, and functions being implemented or monitored by one or more applications on a platform. This data encompasses both structured and unstructured information related to the various activities, workflows, and metrics tracked within the system 100. Examples of such data may include, but are not limited to, supply chain and inventory data, audit trail logs, quality control metrics, regulatory compliance records, etc.

The SOR 208 encompasses a range of enterprise-level software applications and databases that manage and store critical business data across various operational domains. The SOR 208 may pertain to, for example, a manufacturing execution system (MES) 208-1, an enterprise resource planning (ERP) system 208-2, an electronic batch record (EBR) 208-3, a quality management system (QMS) 208-4, and one or more additional systems of record. In some embodiments, the SOR 208 may store real-time data. The SOR 208 may be implemented, for example, on a processor based resource and may serve as a source of data for a given data element (or other piece of information) stored therein, and retrievable over the network 204. Examples of information stored in the SOR 208 may include, but is not limited to, information related to customer services, sales, procurement, production, distribution, accounting, human resources, corporate performance and government, etc.

Returning to the system 100, the system 100 along with the processor(s) 102 includes interface(s) 210 and memory(s) 212. The interface(s) 210 may allow the connection or coupling of the system 100 with one or more other devices, through a wired (e.g., Local Area Network, i.e., LAN) connection or through a wireless connection (e.g., Bluetooth®, Wi-Fi). The interface(s) 210 may also enable intercommunication between different logical as well as hardware components of the system 100.

The memory(s) 212 may be a computer-readable medium, examples of which include volatile memory (e.g., RAM), and/or non-volatile memory (e.g., Erasable Programmable read-only memory, i.e., EPROM, flash memory, etc.). The memory(s) 212 may be an external memory, or internal memory, such as a flash drive, a compact disk drive, an external hard disk drive, or the like. The memory(s) 212 may further include data which either may be utilized or generated during the operation of the system 100.

The system 100 may further include engine(s) 214. The engine(s) 214 may be implemented as a combination of hardware and programming, for example, programmable instructions to implement a variety of functionalities of the engine(s) 214. In examples described herein, such combinations of hardware and programming may be implemented in several different ways. For example, the programming for the engine(s) 214 may be executable instructions. Such instructions may be stored on a non-transitory machine-readable storage medium which may be coupled either directly with the system 100 or indirectly (for example, through networked means). In an example, the engine(s) 214 may include a processing resource, for example, either a single processor or a combination of multiple processors, to execute such instructions. In other examples, the engine(s) 214 may be implemented as electronic circuitry.

The engine(s) 214 includes an input engine 216, a generation engine 218, a rendering engine 220, and other engines 222. The engine(s) 214 may be implemented as a combination of hardware and programming, for example, programmable instructions to implement a variety of functionalities of the engine(s). In examples described herein, such combinations of hardware and programming may be implemented in several different ways. For example, the programming for the engine(s) may be executable instructions. Such instructions may be stored on a non-transitory machine-readable storage medium which may be coupled either directly with the system 100 or indirectly (for example, through networked means). In an example, the engine(s) may include a processing resource, for example, either a single processor or a combination of multiple processors, to execute such instructions. In other examples, the engine(s) may be implemented as electronic circuitry.

The system 100 may further include data 224. The data 224 includes data that is either received, stored, or generated as a result of functions implemented by any of the engine(s) 214 or the system 100. It may be further noted that information stored and available in the data 224 may be utilized by the engine(s) 214 for performing various functions by the system 100. In an example, the data 224 may include input data 226, configuration data 228, and other data 230. The other data 230 may include data generated by the engine(s) 214. It may be noted that such examples are only indicative. The present approaches may be applicable to other examples without deviating from the scope of the present subject matter.

In an example, the system 100 may be configured to render the data or content associated with the presentation format. The presentation format may include one or more interactable components to render dynamic content. The interactable components may be programmable and may provide visual information on a user interface. Further, the content to be rendered may be associated with an organization. In an example, the content may include sales data including regional sales figures, product-specific sales trends, or customer acquisition rates. In another example, the content may include production data, such as manufacturing statistics, quality control metrics, or supply chain data. In yet another example, the data may include human resource data such as employee performance reviews, department headcount, and so on. Further, the data may vary based on different divisions or departments of the organization.

As would be appreciated, the content may be utilized to provide meaningful visual information that enables users to grasp key insights and trends. The content may support data-driven decision making by presenting relevant information to various stakeholders. The content may allow for monitoring and tracking of key performance indicators (KPIs) across business processes, potentially enabling real-time or near real-time reporting on operations. The content may also enable customized reporting, quality management initiatives, organizational transparency, analytics, and benchmarking. In some examples, the content may serve as a foundation for generating insights, improving efficiency, and informing strategic decisions within an organization.

In an example, the system 100 may render the content upon receiving a request from the user. To render the content associated with the presentation format, the system 100 may retrieve the content from various data sources, such as the SOR 208, that may be associated with the one or more interactable components of the presentation format. These data sources may include internal data sources of the organization as well as external data sources. The internal data sources may include, but are not limited to, Enterprise Resource Planning (ERP) systems, Customer Relationship Management (CRM) platforms, Manufacturing Execution Systems (MES), Quality Management Systems (QMS), Business Intelligence (BI) platforms, Internet of Things (IoT) devices and sensors, Supply Chain Management (SCM) systems, and Human Resources Information Systems (HRIS). Each of these internal data sources may provide specialized data sets relevant to their respective domains. Further, examples of the external data sources may include market research databases, economic indicators, which may provide contextual data for business analysis. In some cases, the system 100 may also retrieve content from data lakes, data warehouses, or cloud storage systems that serve as centralized repositories for diverse types of organizational data.

Further, as organizations typically implement role-based access control of the content, the system 100 may check if the user requesting the content rendering is authorized to access such data or not. For example, users may require specific authorization to generate presentation formats or templates based on departmental data. The system may verify user credentials against a centralized authentication system to ensure only authorized personnel can access and create templates using sensitive organizational data. Business administrators may provide configuration data for templates, which can be rendered as web pages or text-based files. Accordingly, the input engine 216 of the system 100 may receive credentials of a user to determine whether the user is authorized to request the data rendering.

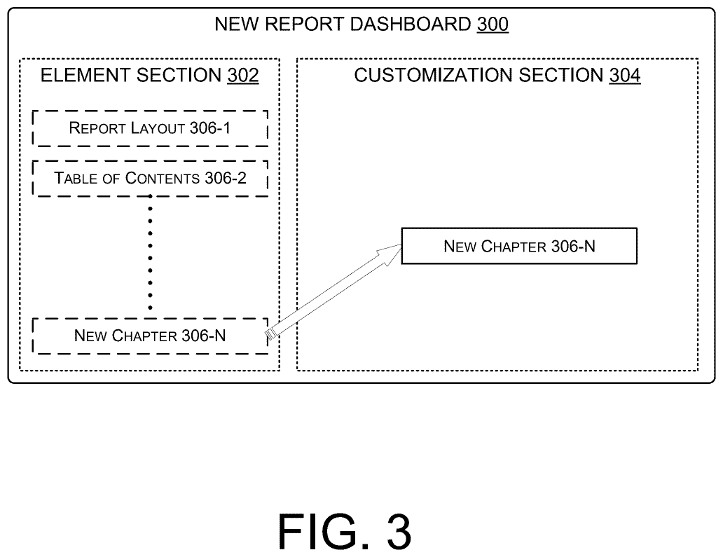

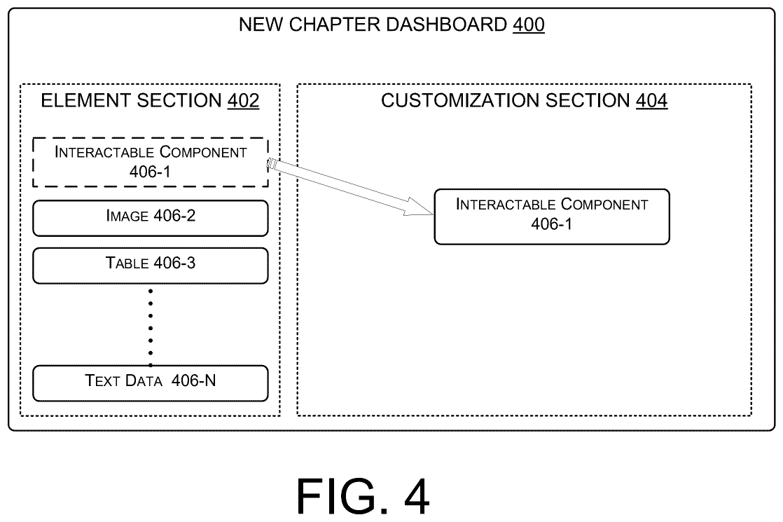

In an example, prior to rendering the content, a user may create and store the presentation formats in the repository 206. To this end, upon confirmation that the user is authorized, the input engine 216 may receive an input, such as a first input, from the user. In an example, the first input may be a request to generate a new presentation format, say for a report. The input may be in the form of mouse clicks and movements, touch inputs, voice commands, drop-down menu, checkbox toggle, and so on. The input engine 216 may store the first input as the input data 226. Based on the input, the input engine 216 may create a user interface (UI) or a dashboard (explained in detail in FIGS. 3 and 4) to enable the user to define various elements of the presentation format. For example, when a business administrator is to generate the presentation format for the report for the first time, the business administrator may provide the first input to the system 100. In response to the first input, the input engine 216 may create the dashboard. The dashboard may enable the business administrator to define the elements for being included in the presentation format.

Once the dashboard is created, the generation engine 218 may receive another input, such as a second input, from the user. As may be understood, the user may provide the second input to the generation engine 218 through the user devices 202. In an aspect, through the second input, the generation engine 218 may enable the user to select a plurality of elements for being included in the presentation format. The plurality of elements may include some elements for rendering dynamic content and some elements for rendering static content. In an example, the elements for rendering the dynamic content may include one or more interactable components, such as widgets. An interactable component is programmable and is to provide content in the form of visual information on the UI. In an aspect, the interactable component may be a container element defining a layout of content to be rendered, image field, chart-based element, text-based input field, or a combination thereof. Each of the one or more interactable components may be associated with an integrated executable code which when executed enables retrieval of data from a data source. As mentioned above, the interactable components may be configured to provide dynamic content. The dynamic content may refer to the content that changes or updates automatically in response to various inputs.

On the other hand, the static content may refer to the content that remains unchanged once the content is created or published. In an example, the elements for rendering the static content may include a fixed image, such as a company logo, contact information, section titles, and so on.

Therefore, the user may select the one or more interactable components or widgets for being included in the presentation format. In an example, the generation engine 218 may enable the user to drag and drop the plurality of elements that may be included in the presentation format. Upon selection of the interactable components, the generation engine 218 may position the selected interactable component within a portion of the dashboard or UI. In an example, the generation engine 218 may configure the presentation format to include different portions for static elements and dynamic elements. Thus, the portion of the UI of the presentation format in which the interactable component is positioned corresponds to a distinct section within the presentation format. For example, a top and bottom sections of the presentation format may contain static elements, such as page numbers or copyright information, while a central area is reserved for dynamic content like real-time data visualizations or user-specific information. In the context of a report, the report may have static elements like title pages, section headers, and page layouts, while the actual data, charts, and tables within these sections may be dynamic and populated based on the latest information. Thus, by separating static and dynamic elements in the presentation format, the system 100 may maintain a consistent structure and user experience while allowing for flexible, real-time content updates and customization options.

In an example, one of shape and relative position of the interactable component is adaptive when being positioned with respect to position of an adjacent element. In an example, the generation engine 218 may allow the user to adjust the dimensions of an interactable components by adaptively resizing the same as it is positioned. The ability provided to the user by the generation engine 218 to change the shape and/or relative position of the interactable component with respect to adjacent elements provides significant flexibility in customizing the UI of the presentation format. This may enable the users to create layouts that best suit specific needs and adapt to various display contexts.

The generation engine 218 may further receive configuration settings to configure the interactable component. The generation engine 218 may receive the configuration settings. The configuration setting may be specified by way of user input or may be retrieved from a set of predefined configuration settings for corresponding interactable components. The configuration settings may refer to a set of parameters or attributes that define the behaviour, appearance, functionality, and performance of the interactable component within the presentation format. The configuration settings may encompass a wide range of adjustable properties that allow for customization and fine-tuning of the interactable component's features and interactions. In an example, the user may retrieve the configuration settings from a set of predefined configuration settings. In an example, the generation engine 218 may present a configuration interface where the user may adjust settings for the interactable component. The configuration settings are stored by the generation engine 218 as the configuration data 228.

Examples of the configuration settings may include, but are not limited to, data source configuration, i.e., the users may configure how the interactable component may interact with the data sources, such as SOR 208. Based on the configuration settings, the interactable component may establish a communication channel with the data source, such as the SOR 208, to retrieve the content. Further, the generation engine 218 may enable the user to configure data refresh intervals for real-time updates, set up database connection parameters, and so on. The configuration settings may also include providing a library of pre-configured settings that the user may apply to the interactable component. Further, the configuration settings may include rules for dynamically changing the interactable component's appearance, e.g., defining thresholds for displaying warning indicators, etc.

Further, based on the configuration settings, the interactable component may render the content as the visual information. For example, in a product quality review report, if the configuration settings specify a heat map format, the interactable component may render defect frequency data across different product components as a color-coded visual representation. In another instance, if the configuration settings indicate a preference for a scatter plot, the interactable component may present product sale rates against production dates, allowing for easy identification of temporal trends. The configuration settings may also specify the use of gauge charts to represent key quality metrics, such as overall customer satisfaction scores, with color-coded zones indicating acceptable and problematic ranges.

In an example, the generation engine 218 may enable the user to configure the interactable component to provide a preview of the visual information based on a subset of content retrieved from the data source, such as the SOR 208. For instance, the interactable component may retrieve and render only the most recent hundred records from the SOR 208 to generate an initial view. In some cases, the preview may use random sampling, selecting a statistically significant portion of the data to create a representative visualization. In an example, the generation engine 218 may allow users to adjust the sample size or apply filters to refine the subset of data being displayed by the preview. Accordingly, the preview functionality may allow users to quickly assess the visual information without loading the entire dataset, especially when dealing with large datasets or complex visualizations that require substantial processing time.

Based on the configuration settings, the generation engine 218 may generate the presentation format comprising content. As described above, the content comprises the visual information provided by the interactable component and other plurality of elements, based on the configuration settings. The generation engine 218 may store the presentation format in the repository 206. As mentioned above, the repository 206 may act as a repository for storing different presentation formats which can be later retrieved from the repository 206. Prior to storing, the generation engine 218 may serialize the presentation format. In an example, the generation engine 218 may convert the presentation format into a format suitable for storage, such as a binary format.

In an alternative example, upon confirmation that the user is authorized, the first input received from the user may be a request to modify a pre-existing presentation format. For instance, the pre-existing presentation format may be created by a first user, such as the business administrator, and may be stored in the repository 206. At a later point in time, a second user, such as the quality manager may retrieve the presentation format to obtain the content based on the presentation format or to make changes in the presentation format. In an example, the second user may be same as the first user. To do so, the second user may provide a second input. Through the second input, the generation engine 218 may enable the second user to manipulate the pre-existing presentation format. For example, the manipulation of the pre-existing template may include resizing, repositioning, or deleting components already present in the presentation format. The generation engine 218 may provide a layering system, to allow the second user to modify the stacking order of components or add new layers to the existing presentation format for more complex visualizations. In addition, the system 100 may enable the second user to replace a component from the pre-existing presentation format with alternatives while maintaining data connections and positioning.

Subsequently, the user device 202 may send a request to render the content of the presentation format. In an example, the business analyst may send the request that includes a name, such as “product_report-template” of the presentation format for being rendered. Upon receiving the request, the rendering engine 220 may retrieve the presentation format from the repository 206. For example, the rendering engine 220 may query the repository 206 to obtain the requested presentation format. Once obtained, the rendering engine 220 may parse the presentation format. Before parsing the presentation format, the rendering engine 220 may de-serialize the presentation format to identify the serialization format. The rendering engine 220 may parse the presentation format according to the serialization format.

Based on the parsing, the rendering engine 220 may reconstruct objects, data structures, or hierarchies that represent the components and layout of the presentation format. The rendering engine 220 may therefore detect relative position of the interactable component and other plurality of components in the presentation format. Upon detection of the position of the components, the rendering engine 220 may retrieve data corresponding to the interactable component from the data sources, such as the SOR 208. In an example, the rendering engine 220 may execute the integrated executable code associated with the interactable component to retrieve data from the configured data source and in conformance with the configuration settings.

In an example, the rendering engine 220 may perform various operations to ensure that the different segments and the content, which is fetched for displaying, is rendered in an appropriate manner in conformance with the arrangement of the interactable components. For example, the rendering engine 220 may determine a portion of the displayable area of the UI for rendering the content as per the presentation format. The size and dimensions of the one or more portions in the displayable area corresponding to the interactable components that may have been configured.

Further, the rendering engine 220 may detect any input for changing position or dimension of the interactable component. For example, the input may include instructions for resizing a window, rotating a window, etc. In response to the change in the position or the dimension of the interactable component, the rendering engine 220 may dynamically adjust the positioning of the other plurality of elements. In an example, while adjusting the positioning of the elements, the rendering engine 220 may ensure that the interactable components remains appropriately positioned and functional within the altered displayable area. Accordingly, the rendering engine 220 may recalculate and adjust the positions of other elements in the UI to maintain overall layout integrity. After the adjustments, the rendering engine 220 may populate the retrieved data at suitable places within the presentation template. The presentation template reflecting the updated data corresponding to the interactable components is displayed on the user device 202.

In an example, the system 100 may also receive a request to generate a printable format of the presentation format. For example, the rendering engine 220 may receive the request from the user device 202. The printable format may refer to a version of the presentation format that is optimized for printing on physical media, such as a paper. Examples of the printable format may include, but are not limited to, Portable Document Format (PDF), Scalable Vector Graphics (SVG), or any other format that generally preserves layout, formatting, and visual elements as they appear during viewing. The printable format may ensure that the final output matches what is seen on a screen during creation, editing, or viewing.

To this end, the rendering engine 220 may generate a descriptive code defining the printable format corresponding to the presentation format. The descriptive code corresponds to code of a device independent printable file format. The descriptive code in the context of device-independent printable file format is used to describe the content and layout of a document in a way that is not tied to any specific output device or printer. The descriptive code may include information regarding rendering of the content. The information may include text information, graphics and images, layout information, color information, metadata, and so on. In an example, the rendering engine 220 may process the descriptive code to provide a preview of the rendered content of the presentation format. Thus, the descriptive code may retain the position of the interactable component (and the generated visual information) along with the other elements that may have been provided in the user interface.

Once the descriptive code is generated, the rendering engine 220 may disable any subsequent change that may be affected to the visual information being rendered by the interactable component. Such disabling of any subsequent change may lock the visual information in the printable format, such that the visual information is uneditable. For example, in the context of an organizational report, the uneditable version of the visual information may be used for taking approvals or e-signatures or for formal circulation/distribution within the organization.

Accordingly, the presentation format may be used for rendering content in different formats, such as web applications and PDF. In addition, the present subject matter enables users to configure the presentation formats according to their preferences, thereby enhancing user experience. Moreso, the interactable components in the presentation formats may ensure up-to-date information display.

FIGS. 3 and 4 provide example template dashboards 300 and 400. In an example, the template dashboards 300 and 400 may be generated or provided by the generation engine 218. FIG. 3 illustrates a schematic block diagram of the dashboard 300 for generating a presentation format for a report, according to an example. In an example, the report may be any analytical report associated with an organization. In another example, the report may be an annual product quality review report. The dashboard 300 may indicate a dashboard for creating a template for a new report. As depicted in FIG. 3, the dashboard 300 comprises an element section 302 and a customization section 304.

The element section 302 may be provided with a set of elements, (represented as elements 306-1, 306-2, . . . , 306-N, and collectively referred to as elements 306). In an example, the generation engine 218 may provide the set of elements on the dashboard 300. The set of elements 306 is selectable based on user input. The selection of the elements 306 may be on an ad-hoc basis or may be based on a predefined layout. For example, the element section 302 includes a report layout element 306-1. Thus, the generation engine 218 may allow the user to define or configure the layout of the report by selecting the element 306-1. Further, the element section 306-2 includes table of contents element 306-2. The generation engine 218 may therefore enable the user to define an outline of the report by indicating various sections, chapters, or other content through selection of element 306-2. In addition, the generation engine 218 may enable the user to create a new chapter by selection of the element 306-N. In an example, the user may add one or more chapters to the report as per the requirement.

The customization section 304 of the dashboard 300 may indicate the elements selected by the user. For example, a system administrator may select any one or more of the elements 306 from the element section 302. Once selected, the selected element(s) may be added to the customization section 304. As depicted in FIG. 3, the system administrator may drag the “new chapter element 306-N” from the element section 302 and drop the same in the customization section 304. In this manner, the generation engine 218 may allow configuring the elements for a user interface.

FIG. 4 illustrates a schematic block diagram of a dashboard 400 for generating a presentation format for a chapter of a report, according to another example. Similar to the dashboard 300, the generation engine 218 may provide chapter dashboard 400 that includes an element section 402 and a customization section 404. The element section 402 contains various elements, such as a set of dynamic content elements and static content elements (represented as elements 406-1, 406-2, . . . , 406-N, and collectively referred to as elements 406), that can be added to a chapter template. These elements include an interactable component 406-1, an image 406-2, a table 406-3, a text data 406-N, and so on. In an example, the interactable component 406-1 may be a container element defining a layout of content to be rendered, image field, chart-based element, text-based input field, or combinations thereof.

The customization section 404 may display a selected element, such as the interactable component 406-1. In an example, as depicted in FIG. 4, the generation engine 218 may enable the user to drag or copy from the element section 402 to the customization section 404. For example, the user may select one or more interactable components 406-1 to be included in the customization section 404. Further, the user may select other elements, such as images for being included in the customization section 404. As explained above, each of the interactable components 406-1 may be associated with a data source to retrieve data for being included in the chapter.

Although the sets of elements 306 and 406 are provided in a list format, it will be appreciated that the generation engine 218 may provide the sets of elements 306 and 406 in another format. For example, the generation engine 218 may provide the sets of elements 306 and 406 as a drop-down menu and the user may select an element from the drop-down menu. In another example, the generation engine 218 may provide the sets of elements 306 and 406 as toggle switches or check boxes, where the user may perform multiple selections. In an example, the number of the elements 306 and 406 may vary based on the type of reports for which the templates are being created.

As described, the report template created based on the dashboard 300 further includes one or more chapter templates defined based on the dashboard 400. For example, a comprehensive annual report template might include chapter templates for “Company Overview,” “Financial Performance,” “Market Analysis,” and “Future Outlook.” These templates are stored in the repository 206 for future retrieval and use, allowing for consistent reporting across different departments.

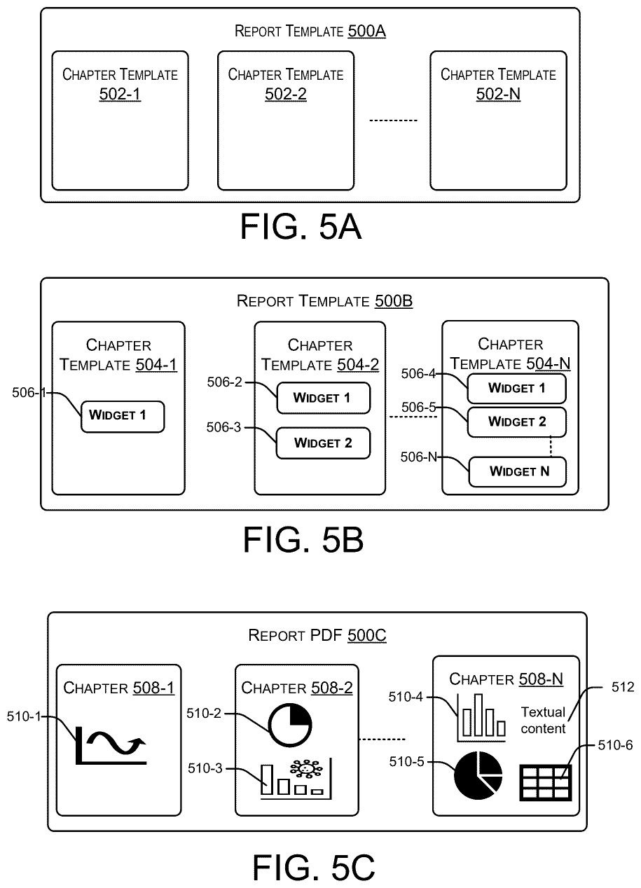

FIGS. 5A, 5B, and 5C illustrate different stages of generating a printable format corresponding to a presentation format for rendering content, using a system, such as the system 100, according to an example. FIG. 5A illustrates example report template 500A at an initial stage, i.e., before configuring any elements in the template. The report template 500A may include one or more chapter templates 502-1, 502-2, . . . 502-N. Here, N may be greater than or equal to 1. The one or more chapter templates 502-1, 502-2, . . . 502-N may be collectively referred to as chapter templates 502 and individually as chapter template 502. The chapter templates 502 represent different sections or parts of the report, allowing for a structured organization of content. In some aspects, each chapter template 502 may correspond to a distinct topic, theme, or category within the overall report.

In an example, the system 100 may create the report template based on inputs received from a user, such as a business administrator. The user may specify the number of chapters, arrangement of various chapters, and any specific formatting requirements for each chapter template 502. In an example, the report template 500A and the chapter templates 502 may be created in advance by a user using a template generating application. This pre-creation may allow for standardized report structures that can be reused across multiple reports or by different users within an organization.

FIG. 5B illustrates an intermediate report template 500B at an element defining stage, according to an example. The intermediate report template 500B may include one or more chapter templates 504-1, 504-2, . . . 504-N. Here, N may be greater than or equal to 1. The one or more chapter templates 504-1, 504-2, . . . 504-N may be collectively referred to as chapter templates 504 and individually as a chapter template 504. The element defining stage is a stage where static and dynamic elements, such as widgets 506-1, 506-2, . . . , 506-N, are defined by the users. The widgets 506-1, 506-2, . . . , 506-N, are collectively referred to as widgets 506 and individually as widget 506. As illustrated, the widget 506-1 has been selected for the chapter template 504-1 by an authorized user thereof. Likewise, widgets 506-2 and 506-3 have been selected by an authorized user of the chapter template 504-2. In addition, the authorized user of the chapter template 504-N may select multiple widgets, including the widgets 506-4, 506-5, . . . 506-N. In an example, the authorized user may be same for each of the chapter templates 504. In another example, the authorized user may be different for each of the chapters 504. As explained above, the chapter templates 504 may include the static content, such as text, in addition to the dynamic content. Once the elements have been selected for each chapter template 504, the report template 500B may be stored in a database, such as the repository 206.

FIG. 5C illustrates a printable format, such as PDF, of the report 500C at a subsequent stage, according to an example. The printable format of the report 500C may include one or more chapters 508-1, 508-2, . . . 508-N. The subsequent stage is a stage where visual information 510-1, 510-2, 510-3, 510-4, 510-5 is incorporated in the chapters 508 based on the selections made by the users. The visual information may include a chart, a graph, etc., to graphically represent the data pertaining to the one or more widgets within each chapter 508. As illustrated, the visual information 510-1 has been incorporated in the chapter 508-1 of the printable format of the report 500C. Further, the visual information 510-2 and 510-3 have been incorporated in the chapter 508-2 of the printable format of the report 500C. As illustrated, the visual indicators 510-4 to 510-6 have been incorporated in the chapter 508-N of the report 500C. In addition, the chapter 508-N also includes static elements, such as textual information 512. The textual content 512 may include introductions, summaries, or any other information pertaining to the report.

The system 100 may employ various techniques to optimize the layout and formatting of the report PDF 500C, ensuring that all elements are properly aligned, sized, and positioned for optimal readability and visual appeal. This may include adjusting font sizes, reorganizing elements to fit within page boundaries, and applying consistent styling across all chapters. In some aspects, the system 100 may also incorporate features such as a table of contents, page numbers, headers, and footers into the report PDF 500C to enhance navigation. The resulting PDF may be designed to be easily printable while maintaining the visual fidelity and information hierarchy of the original presentation format.

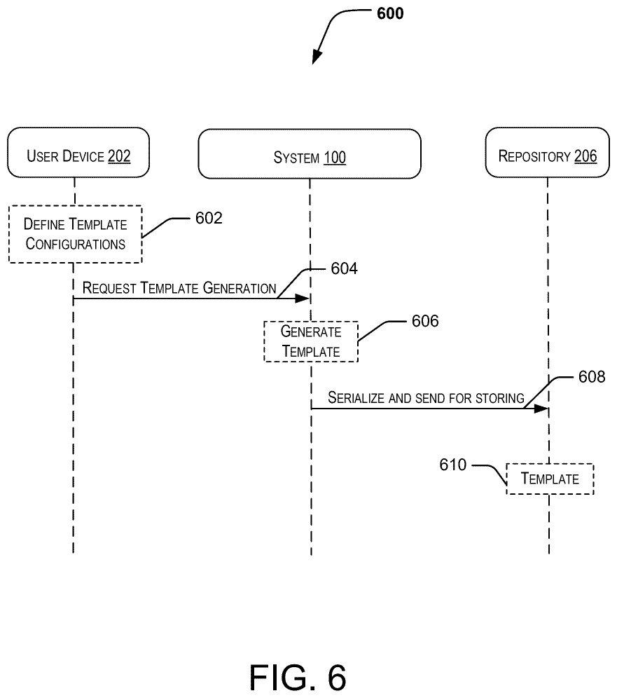

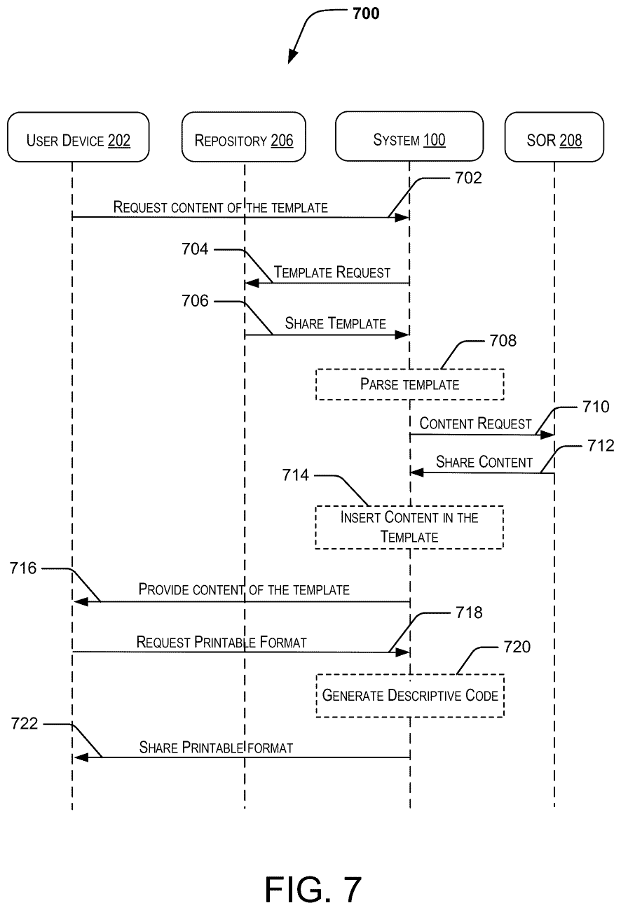

FIG. 6 illustrates a call flow diagram 600 for generating a presentation format for rendering content, according to an example. Further, FIG. 7 illustrates a call flow diagram 700 for generating a printable format corresponding to a presentation format for rendering content, according to another example. The various arrow indicators used in the flow diagrams 600 and 700 depict the transfer of data between the components (internal components of the system 100 or external components coupled to the system 100) of the system 100 and between the applications running in the system 100. The order in which the flow diagrams 600 and 700 are described is not intended to be construed as a limitation, and any number of the described steps may be combined in any order to implement the flow diagrams 600 and 700, or an alternative method. Further, certain steps have been omitted in the flow diagrams for the sake of brevity and clarity.

Referring to FIG. 6, at step 602, a user defines configurations associated with a template or presentation format, through the user device 202. In an example, the user may be a business administrator or system administrator associated with an organization. The template configurations may include defining a layout of the template, positioning of the content to be rendered in the template, types of elements that may be included in the template, and so on. The user may select one or more interactable components, such as widgets, to be included in the template. For example, a user creating a sales dashboard template may define a grid layout, with a real-time sales chart in the top-left, a customer list in the top-right, a data table of recent transactions in the bottom-left, and a performance summary text box in the bottom-right.

At step 604, the user device 202 sends a request to the system 100 to generate the template. In an example, the request sent by the user device 202 includes the template configurations.

At step 606, in response to the request, the system 100 generates the template. In an example, the generation engine 218 may process the configuration information and create a template structure that matches the user's specifications. In an example, the template may be a web-page or a text-based file. Referring to the sales dashboard example, the system 100 may generate a Hyper Text Markup Language (HTML) and Cascading Style Sheets (CSS) structure for the sales dashboard, creating indicators for each specified element and applying the defined layout.

At step 608, the system 100 serializes the template and sends the template to the repository 206 for storage. In an example, the generation engine 218 may serialize the template to convert the template into a format suitable for storage and later retrieval. Upon serialization, the generation engine 218 may send the template for storage to the repository 206. In an example, the generation engine 218 may convert the template into a JavaScript Object Notation (JSON) string or a binary format, then transmit this serialized data to the repository 206.

At step 610, the repository 206 stores the template for being referred to at a later point in time. In an example, the serialized template data is stored in the repository 206 with a unique identifier, thereby allowing the template to be quickly retrieved when needed for rendering a new sales dashboard or editing the existing template.

Referring to FIG. 7, at step 702, the user device 202 sends a request to the system 100 to render the content of the template. In an example, a quality assurance manager may use the user device 202, such as a laptop, to access the company's quality management system and request to generate an annual product quality review report for a specific product.

At step 704, the system 100 requests the repository 206 to retrieve the template. In response to the request from the user device 202, the system 100 may query the repository 206 to obtain the template. For example, the quality management system queries the repository 206 for the “annual_product_quality_review_template” associated with the selected product.

At step 706, the repository 206 shares the requested template with the system 100. In response to the request, the repository 206 may provide the template having sections for product information, manufacturing data, quality control results, and improvement recommendations. The template may also include the widgets based on which visual information may be included in the template.

At step 708, the system 100 parses the template. In an example, the rendering engine 220 may de-serialize and parse the template to detect relative position of the interactable components and other plurality of components in the template. In an example, the system 100 may analyze the template structure, identifying the placement of data tables, charts, text blocks, and input fields for each section of the quality review report.

At step 710, the system 100 may request content associated with the template. For example, the rendering engine 220 may request the SOR 208 to provide content associated with the one or more widgets of the template. In an example, the system 100 sends requests to various data sources of the SOR 208 to retrieve the past year's manufacturing batch records, quality control test results, and previous improvement initiatives.

At step 712, the SOR 208 provides the requested content to the system 100. In an example, the SOR 208 returns data, such as production yield statistics, out-of-specification test results, and status updates on ongoing quality improvement projects.

At step 714, the system 100 inserts the content in the template based on the configuration settings of the template. In an example, the system 100 populates the report template, inserting production data into tables, generating charts for quality control trends, and summarizing improvement initiatives.

At step 716, the system 100 provides the content of the template to the user on the user device 202. In an example, the completed annual product quality review report is displayed on the quality assurance manager's laptop, showing all relevant quality metrics and analyses.

At step 718, the user sends a request to generate a printable format of the content being rendered on the system 100. In response to the rendered content of the template, the user may wish to generate the printable format, such as PDF of the template. For example, the quality assurance manager may click a “Generate PDF” button to create a printable version of the report for distribution purposes.

In response to the request, at step 720, the system 100 generates a descriptive code defining the printable format. The descriptive code corresponds to code of a device independent printable file format. The descriptive code in the context of device-independent printable file format is used to describe the content and layout of a document in a way that is not tied to any specific output device or printer. The rendering engine 220 may generate the descriptive code while retaining the positioning of the widget and the visual information along with other elements. In continuation to the above example, the system 100 generates a PDF version of the quality review report, maintaining the layout and formatting of charts and tables, while optimizing the report for printing (e.g., ensuring all charts are legible when printed, adding page numbers and headers).

At step 722, the system 100 shares the printable format of the content with the user through the user device 202. The system 100 may send the print-ready PDF of the annual product quality review report to the quality assurance manager's laptop, ready for printing or electronic distribution to stakeholders.

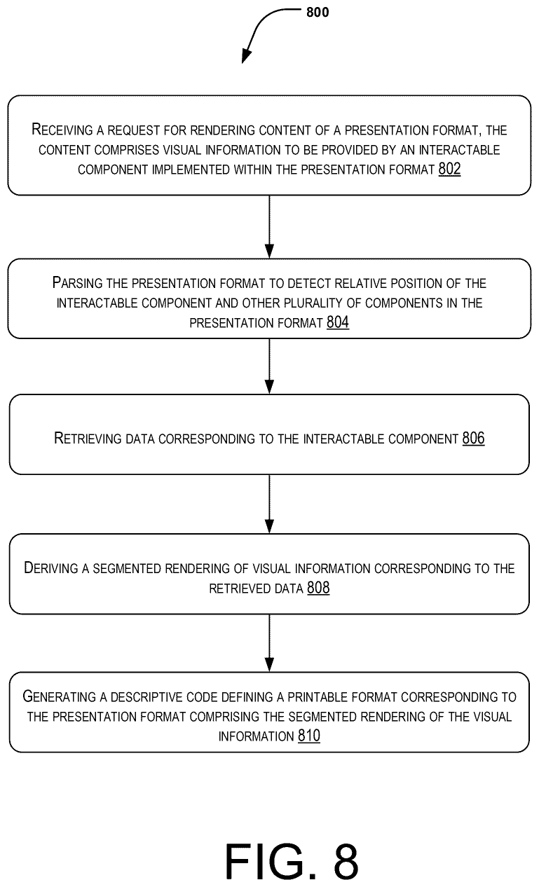

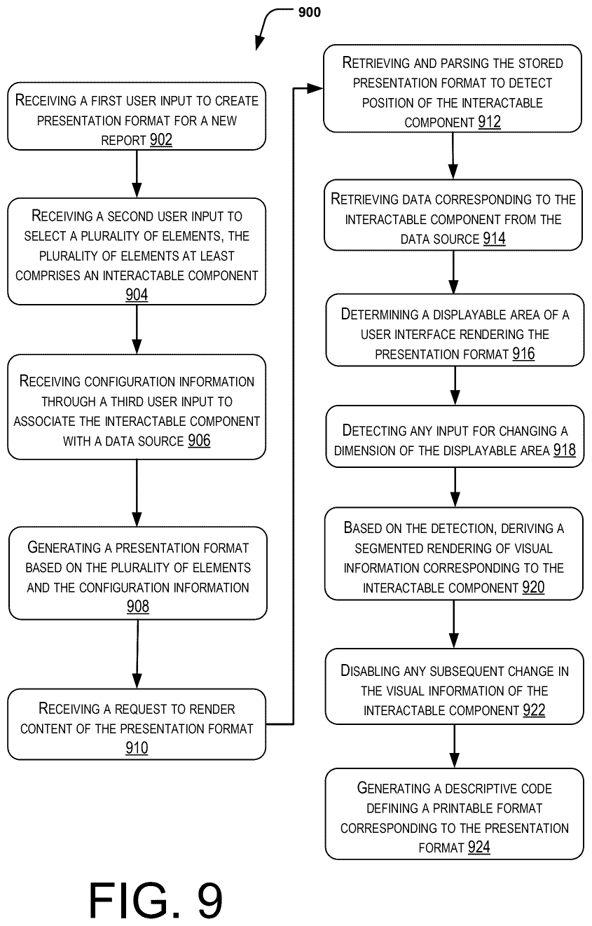

FIG. 8 and FIG. 9 illustrate example methods 800 and 900 for generating a printable format corresponding to a presentation format for rendering content, according to different examples. The order in which the methods are described is not intended to be construed as a limitation, and any number of the described method blocks may be combined in any order to implement the methods, or an alternative method. Further, the methods 800 and 900 may be implemented by processing resource or computing device(s) through any suitable hardware, non-transitory machine-readable instructions, or combination thereof.

It may also be understood that methods 800 and 900 may be performed by programmed computing devices, such as the system 100, as depicted in FIG. 1 and FIG. 2. Furthermore, the methods 800 and 900 may be executed based on instructions stored in a non-transitory computer-readable medium, as will be readily understood. The non-transitory computer-readable medium may include, for example, digital memories, magnetic storage media, such as one or more magnetic disks and magnetic tapes, hard drives, or optically readable digital data storage media. While the methods 800 and 900 are described below with reference to the system 100 as described above; other suitable systems for the execution of these methods may also be utilized. Additionally, implementation of these methods is not limited to such examples.

Referring to FIG. 8, at block 802, the method 800 includes receiving a request for rendering content of a presentation format. The presentation format may be indicative of a template that may include a pre-configured layout to organize and display the content in a consistent manner. The presentation format may be predefined and stored by a user, such as a business administrator. Further, the content may include visual information to be provided by an interactable component implemented within the presentation format. In an example, the interactable component may be a widget configured to provide dynamic content, i.e., the content that changes or updates automatically in response to various inputs. The interactable component may be configured to fetch the dynamic content from a plurality of data sources and provide the dynamic content in a visual form, such as a graph, a chart, etc. In an example, the rendering engine 220 may receive the request for rendering the content.

At block 804, the method 800 includes parsing the presentation format to detect relative position of the interactable component and other plurality of components in the presentation format. In addition to the dynamic content, the presentation format may also include static content, i.e., the content that remains fixed once the content is created or published. To be able to populate the presentation format with the visual form of the dynamic content, the position of the interactable component is detected in the presentation format. In an example, the rendering engine 220 may parse the presentation format to detect the location of the widgets in the template.

At block 806, the method 800 includes retrieving data corresponding to the interactable component. While defining the presentation format, the user may associate the interactable component with one or more data sources, such as the systems of record (SOR) 208. Accordingly, the interactable component may be configured to render the information fetched from the data sources. Examples of information stored in the data sources may include, but is not limited to, information related to, for example, customer services, sales, procurement, production, distribution, accounting, human resources, corporate performance and government, etc. In an example, the rendering engine 220 may retrieve data corresponding to the interactable component.

At block 808, the method 800 includes deriving a segmented rendering of visual information corresponding to the retrieved data. As may be noted, depending on the data sources and the data being retrieved, the visual information may also change. The segmented rendering may include, but is not limited to, a point-in-time snapshot of the visual information rendered at the instant the presentation format is parsed. In an example, the rendering engine 220 may derive the segmented rendering of the visual information. The manner in which the segmented rendering is performed is only exemplary. Such segmented rendering may be performed through other approaches without deviating from the scope of the present subject matter.

At block 810, the method 800 includes generating a descriptive code defining a printable format corresponding to the presentation format comprising the segmented rendering of the visual information. In an example, once the segmented rendering is derived, a descriptive code defining a printable format, such as PDF, may be generated. The descriptive code may be defined in such a manner so as to retain the positioning of the interactable component (and the generated visual information) along with the other elements that may have been provided in the user interface. In an example, the descriptive code may be written in various formats or languages, such as Extensible Markup Language (XML), Hypertext Markup Language (HTML) with CSS, PostScript, or specialized markup languages designed for print. In an example, the rendering engine 220 may generate the descriptive code. The approaches described in the present subject matter enable consistent configuration of user interfaces of dashboards across different quality and/or management processes for dynamic content rendering, while also enabling seamless viewing.

Referring to FIG. 9, at block 902, the method 900 includes receiving a first user input to create a presentation format for a new report. In an example, the input engine 216 may receive the first user input via various user interface elements of the user devices 202. In one aspect, the first user input may be a request to generate a new presentation format, such as for a report or for a chapter in the report. For example, the first user input may include selecting a “Create New Report” button or menu option. In some cases, the first user input may be received through a voice command, gesture, or other input modality supported by the user interface. In the context of organizational reports, the report may represent an analytical report, such as a sales report, audit report, quality report, and so on.

At block 904, the method 900 includes receiving a second user input to select a plurality of elements. In an example, the generation engine 218 may receive the second user input from the user device 202. The plurality of elements being selected based on the second user input may at least include an interactable component. As described above, the plurality of elements may include dynamic elements as well as static elements. The dynamic elements include one or more widgets to provide dynamic content to be included in the report. In an example, before selection of the elements, the user may create a new chapter within the report.

At block 906, the method 900 includes receiving configuration information through a third user input to associate the interactable component with a data source. In an example, the configuration information may include various parameters, settings, or instructions that establish a connection or association between the interactable component and the data source. The generation engine 218 may receive the configuration information to specify the type or identity of the data source, connection details (such as network address) for accessing the data source, update frequency, etc.

At block 908, the method 900 includes generating a presentation format based on the plurality of elements and the configuration information. The presentation format may be indicative of a template that may include a pre-configured layout to organize and display the content in a consistent manner. In an example, the generation engine 218 may generate the presentation format and may store the same in the repository 206.

At block 910, the method 900 may include receiving a request to render content of the presentation format. In an example, the rendering engine 220 may receive the request for rendering the content of the presentation format. The request may be received from a same user who has created the presentation template or from a different user.

At block 912, the method 900 includes retrieving the presentation format and parsing the presentation format to detect relative position of the interactable component and other plurality of components in the presentation format. In an example, the rendering engine 220 may retrieve the presentation format from the repository 206. As described above, in addition to the dynamic content, the presentation format may also include static content, i.e., the content that remains fixed once the content is created or published. To be able to populate the presentation format with the visual form of the dynamic content, the position of the interactable component is detected in the presentation format. In an example, the rendering engine 220 may parse the presentation format to detect the location of the various elements.

At block 914, the method 900 includes retrieving data corresponding to the interactable component. As explained above, while creating the presentation format, the interactable component may be associated with one or more data sources, such as systems of record (SOR) 208. Accordingly, the interactable component may be configured to render the information fetched from the data sources. Examples of information stored in the data sources may include, but is not limited to, information related to, customer services, sales, procurement, production, distribution, accounting, human resources, corporate performance and government, etc. In an example, the rendering engine 220 may retrieve data corresponding to the interactable component.

At block 916, the method 900 includes determining a displayable area of a user interface rendering the presentation format. In an example, the rendering engine 220 may determine various aspects associated with the user interface. For example, the rendering engine 220 may determine physical dimensions of a device screen, screen resolution, orientation of a device on which the content is to be rendered, available space for content display, accounting for elements like toolbars, sidebars, or other UI components that may occupy screen real estate, etc.

At block 918, the method 900 includes detecting any input for changing a dimension of the displayable area. In an example, the rendering engine 220 may detect various user actions and system events, such as window resizing where the user may drag edges or corners of the application window to resize it, device rotation where the user may rotate the device from portrait to landscape orientation or vice versa, etc. In an example, the user on a desktop may resize their browser window from full screen to occupy only half the screen, prompting the application to adjust its layout accordingly. Such changes would be detected by the rendering engine 220.

At block 920, the method 900 includes deriving a segmented rendering of visual information corresponding to the interactable component, based on the detection. In an example, the rendering engine 220 may derive the segmented rendering of the visual information from the SOR 208. The rendering engine 220 may populate the segmented rendering of the visual information in the user interface and render the presentation format or template to a user on the user device 202.

At block 922, the method 900 includes disabling any subsequent change in the visual information of the interactable component. In an example, the rendering engine 220 may disable any subsequent changes that may be affected to the visual information being rendered by the interactable component. Such disabling of any subsequent change may lock the visual information in the printable format, such that the visual information is uneditable.

At block 924, the method 900 includes generating a descriptive code defining a printable format corresponding to the presentation format. In an example, once the segmented rendering is derived, a descriptive code defining a printable format, such as PDF, may be generated. In an example, the rendering engine 220 may generate the descriptive code.

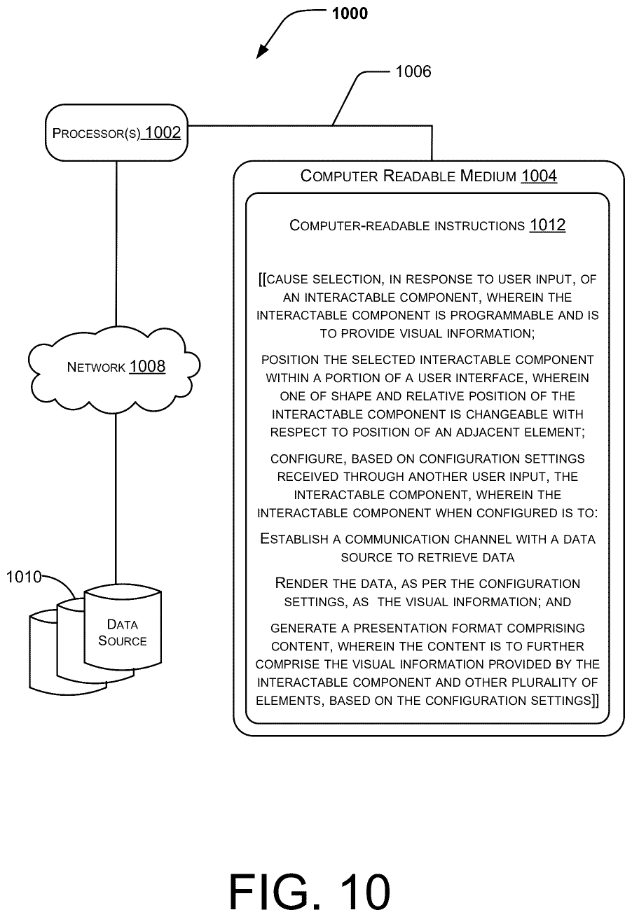

FIG. 10 illustrates a computing environment 1000 implementing a non-transitory computer-readable medium for providing consistent rendering of information in different presentation formats, according to an example. In an example, the computing environment 1000 includes processor(s) 1002 communicatively coupled to a non-transitory computer readable medium 1004 through a communication link 1006. In an example, the processor(s) 1002 may have one or more processing resources for fetching and executing computer-readable instructions from the non-transitory computer readable medium 1004. The processor(s) 1002 and the non-transitory computer readable medium 1004 may be implemented, for example, in the system 100 (as has been described in conjunction with the preceding figures).

The non-transitory computer readable medium 1004 may be, for example, an internal memory device or an external memory device. In an example, the communication link 1006 may be a network communication link. The processor(s) 1002 may access the non-transitory computer readable medium 1004 through a network 1008. The network 1008 may be a single network or a combination of multiple networks and may use a variety of communication protocols. The processor(s) 1002 and the non-transitory computer readable medium 1004 may also be communicatively coupled to a data source 1010 over the network 1008. The data source 1010 may include, for example, systems of record (SOR).

In an example, the non-transitory computer readable medium 1004 includes a set of computer readable instructions (hereinafter may also be referred to as instructions) 1012 which may be accessed by the processor(s) 1002 through the communication link 1006. Referring to FIG. 10, in an example, the non-transitory computer readable medium 1004 includes instructions 1012 that may cause the processor(s) 1002 to cause selection of an interactable component. The interactable component may be selected in response to a user input. The interactable component may be programmable and is configured to provide visual information. For example, the interactable component may be a widget that may be selected for a report dashboard. The widget may be configured to provide data in the form of charts, graphs, and so on.

Upon selection of the interactable component, the instructions 1012 may cause the processor(s) 1002 to position the selected interactable component within a portion of a user interface. As the user interface may include other elements, such as textual content and images, the interactable component may be positioned in a space available on the user interface. Accordingly, one of a shape and relative position of the interactable component is changeable with respect to position of an adjacent element.

Upon positioning the interactable component within the user interface, the instructions 1012 may cause the processor(s) 1002 to configure the interactable component. The interactable component may be configured based on configuration settings received through another user input. The configuration settings may enable the interactable component to perform one or more functions. The configuration settings may include parameters, such as data source selection, update frequency, display format, and so on.

To configure the interactable component, the instructions 1012 may further cause the processor(s) 1002 to establish a communication channel with the data source 1010 to retrieve data. The data source 1010 may represent available data sources that include relational data repositories and operational data stores including structured and unstructured data (e.g., collections of files, documents, sheets, etc.). Upon establishing the communication channel, the instructions 1012 may cause the processor(s) 1002 to render the data as per the configuration settings. The data may be rendered as the visual information. In an example, rendering the data as the visual information includes providing the data as a graph, a chart, a heat map, a table, and so on.

Additionally, the instructions 1012 may cause the processor(s) 1002 to generate a presentation format comprising content based on the configuration settings. The presentation format may include, but is not limited to, a Portable Document Format (PDF). The content may include visual information provided by the interactable component and other plurality of elements. Thus, the presentation format may include static elements as well as dynamic elements (the interactable component).

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

We claim:

1. A system comprising:
a processor; and
a machine-readable storage medium comprising instructions executable by the processor to:
enable selection, through user input, of an interactable component, wherein the interactable component is programmable and is to provide visual information on a user interface;
position the selected interactable component within a portion of the user interface, wherein one of shape and relative position of the interactable component is changeable with respect to position of a plurality of other elements in the user interface;
configure, based on configuration settings received through another user input, the interactable component, wherein the interactable component when configured is to:
establish a communication channel with a data source to retrieve data;
render the data, as per the configuration settings, as the visual information; and
generate a presentation format comprising content, wherein the content is to further comprise the visual information provided by the interactable component based on the configuration settings, and the plurality of other elements.

2. The system as claimed in claim 1, wherein the instructions are executable to further:
determine a displayable area of the user interface rendering the presentation format, wherein the displayable area is to render visual information provided by the interactable component;
detect any input for changing a dimension of the displayable area; and
responsive to the change in the dimension, adjust the position of at least the interactable component with respect to altered displayable area and the other plurality of elements.

3. The system as claimed in claim 1, wherein the interactable component is a container element defining a layout of content to be rendered, image field, chart-based element, text-based input field, or combinations thereof.

4. The system as claimed in claim 1, wherein the configuration settings are retrieved from a set of predefined configuration settings.

5. The system as claimed in claim 1, wherein the portion of the user interface within which the interactable component is positioned corresponds to a distinct section within the presentation format.

6. The system as claimed in claim 1, wherein the instructions are executable to cause the interactable component to provide a preview of the visual information based on a subset of data retrieved from the data source.

7. The system as claimed in claim 1, wherein the instructions are executable to generate further instructions to generate a descriptive code defining a printable format corresponding to the presentation format.

8. The system as claimed in claim 1, wherein the instructions are executable to disable any change in the visual information being rendered by the interactable component on detection of an event or in response to a user input.

9. The system as claimed in claim 1, wherein the presentation format is one of a web-page, and a text-based file.

10. A method comprising:
receiving a request for rendering content of a presentation format, wherein the content comprises visual information to be provided by a programmable interactable component implemented within the presentation format;
parsing the presentation format to detect relative position of the interactable component and other plurality of components in the presentation format;
retrieving data corresponding to the interactable component;
deriving a segmented rendering of visual information corresponding to the retrieved data; and
generating a descriptive code defining a printable format corresponding to the presentation format comprising the segmented rendering of the visual information.

11. The method as claimed in claim 10, wherein the descriptive code corresponds to code of a device independent printable file format.

12. The method as claimed in claim 10, wherein the descriptive code is processed to provide a preview of the rendered content of the presentation format.

13. The method as claimed in claim 10, the method comprising:
determining a displayable area of a user interface rendering the presentation format, wherein the displayable area is to render visual information provided by the interactable component;
detecting any input for changing a dimension of the displayable area; and
responsive to the change in the dimension, deriving the segmented rendering of the visual information.

14. The method as claimed in claim 10, wherein the interactable component is a container element defining a layout of content to be rendered, image field, chart-based element, text-based input field, or combinations thereof.

15. The method as claimed in claim 10, wherein a portion of a user interface within which the interactable component is positioned corresponds to a distinct section within the presentation format.

16. The method as claimed in claim 10, wherein the deriving the segmented rendering comprises disabling any subsequent change in the visual information of the interactable component.

17. A non-transitory computer-readable medium comprising instructions, the instructions being executable by a processing resource of a system, to:
cause selection, in response to user input, of an interactable component, wherein the interactable component is programmable and is to provide visual information;
position the selected interactable component within a portion of a user interface, wherein one of shape and relative position of the interactable component is changeable with respect to position of an adjacent element;
configure, based on configuration settings received through another user input, the interactable component, wherein the interactable component when configured is to:
establish a communication channel with a data source to retrieve data;
render the data, as per the configuration settings, as the visual information; and
generate a presentation format comprising content, wherein the content is to further comprise the visual information provided by the interactable component and other plurality of elements, based on the configuration settings.

18. The non-transitory computer-readable medium as claimed in claim 17, wherein the interactable component is a container element defining a layout of content to be rendered, image field, chart-based element, text-based input field, or combinations thereof.

19. The non-transitory computer-readable medium as claimed in claim 17, wherein the configuration settings are retrieved from a set of predefined configuration settings.

20. The non-transitory computer-readable medium as claimed in claim 17, wherein the portion of the user interface within which the interactable component is positioned corresponds to a distinct section within the presentation format.
